(19) United States
(12) Patent Application Publication
(10) Pub. No.: US 2016/0110673 A1
(43) Pub. Date: Apr. 21, 2016

(54) METHOD AND SYSTEM FOR DETERMINING MATURITY OF AN ORGANIZATION

(71) Applicant: Wipro Limited, Bangalore (IN)

(72) Inventors: Sreenivas Kunapuli, Hyderabad (IN); Ritesh Kumar Jain, Bangalore (IN)

(21) Appl. No.: 14/559,163

(22) Filed: Dec. 3, 2014

(30) Foreign Application Priority Data
Oct. 15, 2014 (IN) 5153/CHE/2014

(51) Int. Cl. G06Q 10/06

(52) U.S. Cl. CPC G06Q 10/06393

(57) ABSTRACT

The present disclosure relates to a method and a system for determining digital maturity of an organization for digital enablement. In one embodiment, the method and system determines a weightage value of one or more digital parameters and further determines a final digital maturity index based on the weightage value and one or more digital indices associated with the one or more digital parameters. The method further determines a digital satisfaction index to determine the satisfaction level of the users in determining the digital maturity of the organization. Thus the method and system determines digital maturity of the organization so as to enable digital programs, to determine the focus area for digital maturity, to provide transparency of digital information to managers, to prioritize and implement functions significant for the organization and to identify differentiators for the organization in the context of digital footprint.

This application claims the benefit of Indian Patent Application Serial No. 5153/CHE/2014 filed Oct. 15, 2014, which is hereby incorporated by reference in its entirety.

### FIELD

The present subject matter is related, in general to digital infrastructure of an organization, and more particularly, but not exclusively to method and system for determining digital maturity of an organization.

### BACKGROUND

Presently most of the businesses of organizations are digitally enabled with the advancements in the technology. Emergence of new technology areas and transformation of existing technologies is occurring at a fast pace and therefore, more organizations implement new technologies and advanced digital means to conduct businesses. However the organizations are not able to evaluate the digital maturity that addresses the core functions of digital enablement of the organization. Further, the goals, objectives and digital requirements of the organizations may vary from one organization to another depending on the type and size of business, market environment and so on. Furthermore, there exists a huge confusion between existing practices and digital standards to implement a digital business model.

Therefore, there is a need to provide a method and a system to assess the digital maturity of an organization and to define the digital maturity suitable to requirements, goals and objectives of the organization.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method of determining digital maturity of an organization. The method receives a first data associated with one or more digital parameters related to digital infrastructure of the organization. Based on the received data, the method associates a weightage value to the one or more digital parameters and determines one or more digital indices for the one or more digital parameters. The digital indices are determined based on a second data provided by the one or more users in response to one or more queries associated with the one or more digital parameters. Upon determining the digital indices, the method determines a final digital maturity index based on the associated weightage value and the one or more determined digital indices of the one or more digital parameters.

Further, the present disclosure relates to a system for determining digital maturity of an organization. The system comprises a memory communicatively coupled to the processor, wherein the memory stores processor-executable instructions, which, on execution, cause the processor to receive, from one or more users, a first data associated with one or more digital parameters related to digital infrastructure of the organization. The processor is further configured to associate a weightage value to the one or more digital parameters based on the received data and determine one or more digital indices for the one or more digital parameters. The system determines the one or more digital indices based on a second data provided by the one or more users in response to one or more queries associated with the one or more digital parameters. The system further determines a final digital maturity index based on the associated weightage value and the one or more digital indices of the one or more digital parameters.

Furthermore, the present disclosure relates to a non-transitory computer readable medium including instructions stored thereon that when processed by at least one processor cause a system to perform the act of receiving, from one or more users, a first data associated with one or more digital parameters related to digital infrastructure of the organization. Further, the instructions cause the processor to perform the acts of associating a weightage value to the one or more digital parameters based on the received data and determining one or more digital indices for the one or more digital parameters. The digital indices are determined based on a second data provided by the one or more users in response to one or more queries associated with the one or more digital parameters. The instructions further cause the processor to perform the act of determining a final digital maturity index based on the associated weightage value and the one or more determined digital indices of the one or more digital parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates architecture of system for determining digital maturity of an organization in accordance with some embodiments of the present disclosure;

FIG. 2 illustrates a block diagram of a digital maturity determination device in accordance with some embodiments of the present disclosure;

FIG. 3 illustrates a flowchart of a method of determining digital maturity of the organization in accordance with some embodiments of the present disclosure;

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a system for determining digital maturity of an organization for digital enablement. The digital maturity of an organization is assessed based on one or more core functions or digital parameters of digital enablement including Digital Engagement, Digital Experience, Digital Commerce, Business Process Management (BPM), and Digital Integration. The organization can choose one or more appropriate areas based on their needs and requirements and can assess the digital maturity based on their chosen areas. In one embodiment, the method and system determines a weightage value of each of the digital core functions and further determines a final digital maturity index based on the weightage value and one or more digital indices associated with the one or more digital parameters. The method further determines a digital satisfaction index to determine the satisfaction level of the users in determining the digital maturity of the organization. Thus the method and system determines digital maturity of the organization so as to enable digital programs, to determine the focus area for digital maturity, to provide transparency of digital information to managers, to prioritize and implement functions significant for the organization and to identify differentiators for the organization in the context of digital footprint.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

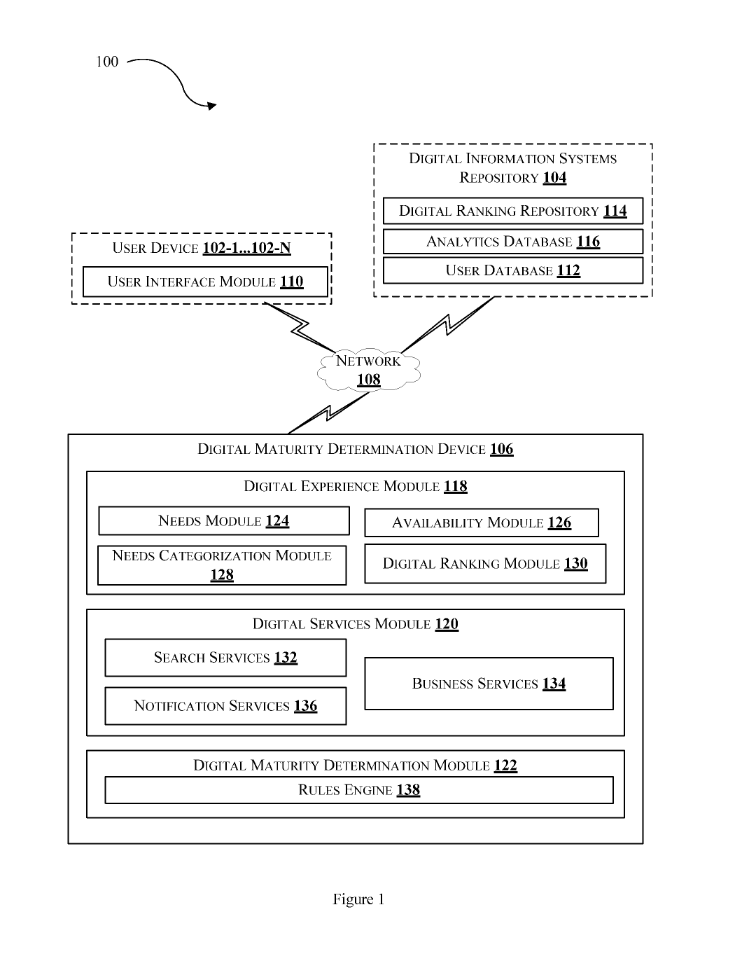

FIG. 1 illustrates architecture of system for determining digital maturity of an organization in accordance with some embodiments of the present disclosure.

As shown in FIG. 1, a system 100 for determining digital maturity of an organization comprises one or more components coupled with each other. In one implementation, the system 100 is accessed by one or more users through one or more digital channels or user devices 102-1, 102-2, . . . 102-N (hereinafter collectively referred to as user device 102). Examples of the user device 102 may include, but are not limited to, a portable computer, a personal digital assistant, a handheld device, or a web service provider.

The user device 102 is communicatively coupled with digital information systems repository (DIS) 104 and a digital maturity determination device (DMDD) 106 via a communication network 108. In one embodiment, the user device 102 comprises a user interface module 110 to enable the user to access the DMDD 106 and the DIS 104. The user interface module 110 receives user login information from one or more users, verifies the received login information with already existing login information previously stored in a user database 112 of the DIS 104. Upon verification, the user is authenticated to communicate with the DMDD 106 and access the DIS 104. Further, the user interface module 110 also classifies the user into one or more categories based on the authentication. In one embodiment, the user interface module 110 categorizes the user including but not limited to Employee, Supplier, Customer, Investor, Admin or SME. In another embodiment, the user may be categorized as one of Employee—Admin, Employee—SME and so on.

In addition to the user login information, the user database 112 also stores information related to mapping of users to various digital needs and User data. In one embodiment, the User data may be information related to user's gap on digital asks versus digital haves. The DIS 104 also comprises a digital ranking repository 114 to store “Market availability” information. In one embodiment, the market availability information is the information of various features that impact the digital footprint of the organization. The market availability information is collected based on the trends and analysis available in the industry. For example, RSS feeds in the context of digitalization will be collected and stored as market availability information in the digital ranking repository 114. The digital ranking repository 114, in one embodiment, may be structured digital ranking repository. The DIS 104 further comprises an analytics database 116 to store analytics data used for analysis on the usage of digital need. For example, the analytics data may include data used to check for patterns of the digital needs, data related to different kinds of issues these digital needs are being used for and the data about volumetric on the number of users having the same digital need and data required for connecting such users. The analytics database 116 is accessed by the DMDD 106 to execute upon the analytics data to analyze the usage of digital needs of the user.

The DMDD 106 accesses the DIS 104 to determine digital maturity of the organization. In one embodiment, the DMDD 106 comprises a digital experience module 118, a digital services module 120 and a digital maturity determination module 122 to enable determination of digital maturity index of the organization. The digital experience module 118 enables users to access the digital needs, conduct analysis of Need versus Want, assess market availability and criticality of a digital need vis-à-vis in relation to number of users having the same digital need, conduct market research to generate information, and assess channel applicability. In one embodiment, the digital experience module 118 comprises at least a needs module 124, an availability module 126, a needs categorization module 128, and a digital ranking module 130.

The needs module 124 enables execution of one or more functions related to the Digital Platform to assess the needs of the user. In one embodiment, the needs module 124 provides one or more user interfaces to avail various Services provided by the DMDD 106. Examples of the Services include Application Services, Search Services, Notification Services and Publishing Services and so on. The Services are provided by the digital services module 120 of the DMDD 106. In one embodiment, the digital services module 120 comprises a Business Services module 132, a Search Services module 134, and a Notification Services module 136. The Business Services module 132 provides one or more services that enable the organization to run the business in a normal manner For example, admin services for administrative activities, support services for support activities, content services for handling content related to organization. The Business Services module 132 enables the user to access the services based on their access rights assigned during the user classification. Based on the access rights, the user can avail the services as an individual or a group and conduct transactions in the business. The user may also avail any service by conducting search based on the user needs. In one embodiment, the Search Services module 134 enables the user to perform search among the services, interact with the search framework and retrieve the search results. The user may also be informed about any changes in the Services like addition of new Service, or removal of any existing Service or events. In one embodiment, the Notification Services module 136 sends one or more notifications to inform the user of events on the system. Examples of the notifications may include change notifications, approval notifications, audit notification and so on. The Notification Services module 136 notifies the user when new Services are published which relate to publishing simple content pages that do not require complicated tools or specific technical knowledge to install and maintain.

Upon determining the needs of the user, the needs available in the market are also analyzed. In one embodiment, the availability module 126 determines one or more digital needs available in the market. The availability module 126 determines information on digital needs by conducting a prior market research using the Digital Ranking Module 130 and stores such information in the structured Digital Ranking repository 114. Further, the availability module 126 enables the user to access the stored information based on the access rights assigned to the user to analyze the needs versus want of the digital needs contextual to the organization. The need categorization module 128 extracts the digital needs related to the categorized user. In one embodiment, the need categorization module 128 is configured to categorize the digital needs stored in the structured digital ranking repository 114 based on user classification and enables the extraction of the categorized need information from the digital ranking repository 114.

The Digital Ranking module 130 enables capturing of structured data related to digital parameters of digital enablement of the organization. In one embodiment, the Digital Ranking module 130 receives data in structured format from the various resources such as, for example, RSS feeds from the Internet and processes such data to associate one or more weightage values to the digital parameters. Based on the weightage values of the digital parameters and the data thus received, the DMDD 106 determines the digital maturity of the organization. In one embodiment, the digital maturity determination module 122 comprises a rules engine 138 for determining digital maturity index indicative of digital maturity of the organization.

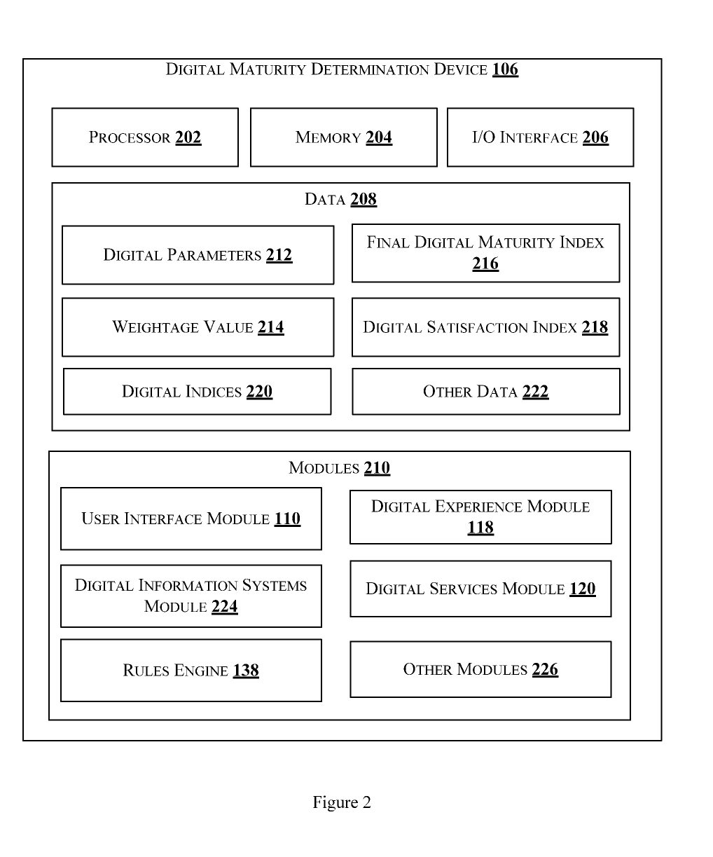

The DMDD 106 may be one of the possible variations of the DMDD 106 described in greater details below with reference to FIG. 2. As shown in FIG. 2, the DMDD 106 includes a central processing unit (“CPU” or “processor”) 202, a memory 204 and an I/O interface 206. The I/O interface 206 is coupled with the processor 202 and an I/O device. The I/O device is configured to receive inputs via the I/O interface 206 and transmit outputs for displaying in the I/O device via the I/O interface 206.

The DMDD 106 further comprises data 208 and modules 210. In one implementation, the data 208 and the modules 210 may be stored within the memory 204. In one example, the data 208 may include one or more digital parameters 212, weightage value 214, final maturity index 216, digital satisfaction index 218, digital indices 220 and other data 222. In one embodiment, the data 208 may be stored in the memory 204 in the form of various data structures. Additionally, the aforementioned data can be organized using data models, such as relational or hierarchical data models. The other data 222 may be used to store data, including temporary data and temporary files, generated by the modules 210 for performing the various functions of the DMDD 106.

The modules 210 may include at least the digital experience module 110, the digital services module 120, the rules engine 138, and a digital information systems module 224. In one embodiment, the user interface module 110 may be configured within the DMDD 106. In another embodiment, the user interface module 110 may be configured within the user device 102. The modules 210 may also comprise other modules 226 to perform various miscellaneous functionalities of the DMDD 106. It will be appreciated that such aforementioned modules may be represented as a single module or a combination of different modules.

In operation, the digital information systems repository (DIS) 104 is accessed by one or more users to retrieve data associated with one or more digital parameters for digital enablement of the organization. The user interface module 110 is configured to validate a user who wishes to access or collaborate with the DIS 104. In one embodiment, the user interface module 110 receives the login details or the user account information of a user and authenticates the user based on valid login information. The user is authenticated by comparing the user account information received from the user with login information previously stored at the time of registering the user.

Upon validating the authenticity of the user, the user interface module 110 categorizes or classifies the user into one or more categories including Employee, Supplier, Customer, Investor, and so on. In another embodiment, the user may be categorized as one of Employee- Admin, Employee- SME and so on. Each categorized user may be assigned with one or more access controls on the DIS 104 determined by the rules engine 138. The rules engine 138 may be implemented by, for example, the processor 202 configured to determine the one or more access controls based on user data stored in the user database 112 and to assign the access controls to the categorized user. Based on the access controls, the user may access or retrieve the data stored in the analytics database 116 and the user database 112.

The user interface module 110 further receives a first data associated with the one or more digital parameters 212 related to digital infrastructure of the organization. The user is provided with a series of questions related to the one or more digital parameters based on the category of the user. In response to the queries, the user provides the first data related to the one or more digital parameters 212 including, but not limited to, digital engagement, digital experience, digital commerce, business process management (BPM) and digital integration.

Digital Engagement ensures that the customer is engaged in a consistent manner across the various models of engagement so as to have a satisfactory engagement with the user. The user may be for example, a customer, an employee or a partner who promises maximum increase of business income. Digital Experience focusses on the aspects related to customer experience across the various channels, focusing on experience targeting, UX Design, Communities, multi-screen worlds etc. Digital Commerce focus on multi-channel campaign management advances, focus on predictive analytics, next-best-offer, social selling etc., so as to enable commerce through various channels like mobile, voice, online and so on. BPM focusses on improvement efforts to deliver incremental improvements and/or transformational business outcomes so as to have consistent and standard processes in customer's perspective. Finally, Digital Integration ensures to have integration across various systems like Digital Media, Multi-channel integration, analytics, customer service, marketing and sales systems to create a digital media ecosystem.

Upon receiving the first data, the digital ranking module 130 determines a weightage value 214 corresponding to the one or more digital parameters 212 based on the received first data and associates the determined weightage value 214 to the one or more digital parameters 212. The weightage value for example may vary from 0 to 1. The digital ranking module 130 associates any value between 0 and 1 to each of the one or more digital parameters 212 based on the first data and stores the associated weightage values in the digital ranking repository 114 for further processing.

The user interface module 110 furthermore receives a second data in response to queries associated with the one or more digital parameters 212. Based on the received second data, the rules engine 138 determines one or more digital indices 220 of corresponding one or more digital parameters 212. In one embodiment, the rules engine 138 determines one or more digital indices 220 including, but not limited to, a Digital Engagement Index, a Digital Experience Index, a Digital Commerce Index, a Digital Process Index and a Digital Integration Index. The Digital Engagement Index is indicative of aspects related to how the customers will engage with the organization using the various channels available including mobile, web, phone etc. The Digital Experience Index is indicative of the experience across channels and measure of the consistency and customer stickiness across channels. The Digital Commerce Index is indicative of evaluation of the market data available to identify the organizations footprint in commerce using online channels. The Digital Process Index is indicative of enablement of the processes and making them paperless and providing visibility required for the organization. The Digital Integration Index will measure how integrated are the organizations systems both within and outside the organization. Outside organization systems will include for example, vendors and partner systems. In one example, the values of the one or more digital indices may vary from 1 to 5.

Based on the weightage value and the one or more digital indices 220 determined as above, the rules engine 138 determines the final maturity index indicative of the digital maturity of the organization. In one embodiment, the rules engine 138 retrieves the stored weightage values 214 of corresponding one or more digital parameters 212 from the digital ranking repository 114 via the digital information systems module 224. The digital information system module 224 provides a user interface to the rules engine 138 to enable access of the stored weightage values 214 from the digital ranking repository 114. The rules engine 138 determines a total of the stored weightage values 214 to obtain a total weightage value.

The rules engine 138 determines one or more digital maturity indices of the one or more digital parameters 212 based on the weightage values 214 and one or more predetermined capability factors associated with the one or more digital parameters 212. In one embodiment, one capability factor for each digital index is predetermined and stored in the memory 204. For example, the capability factor is 0.2 for digital index ‘1’, capability factor is 0.4 for digital index ‘2’, capability factor is 0.6 for digital index ‘3’, capability factor is 0.8 for digital index ‘4’ and capability factor is 1.0 for digital index ‘5’. The rules engine 138 determines one or more digital maturity indices by multiplying the capability factor of one or more digital parameters 212 with the corresponding weightage value 214 as illustrated in equation (1) below:

Digital Maturity Index of a digital parameter=Weightage* Capability for Level (1)

The rules engine 138 further determines the total of the one or more digital maturity indices to obtain a total digital maturity index as illustrated in equation (2) below:

Digital Maturity Index of the organization=Digital Maturity Index of Digital Engagement+Digital Maturity Index of Digital Experience+Digital Maturity Index of Digital Commerce+Digital Maturity Index of Business Process Management+Digital Maturity Index of Integration (2)

The final maturity index 216 of the organization is determined based on the total digital maturity index of the organization, a predetermined maximum capability factor and the total weightage value as mentioned in the below equation (3):

The final Digital Maturity Index (DMI) of the organization=(Total Digital maturity index*predetermined maximum capability factor)/Total weightage value (3)

The rules engine 138 also determines a digital satisfaction index (DSI) 218 to determine the satisfaction level of the users using the DMDD 106. In one embodiment, the rules engine 138 provides one or more queries related to satisfaction level of the users about the DMDD 106 and receive data in response to queries from the users. Based on the received data, the rules engine 138 determines the DSI 218. If the DSI 218 is determined to be lesser than a predetermined satisfaction threshold value, then the rules engine 138 enables modification of the one or more queries associated with the one or more digital parameters 212. To ensure seamless operation of the DMDD 106, the digital services module 120 continue to provide one or more services like search services, business services and notification services to the user.

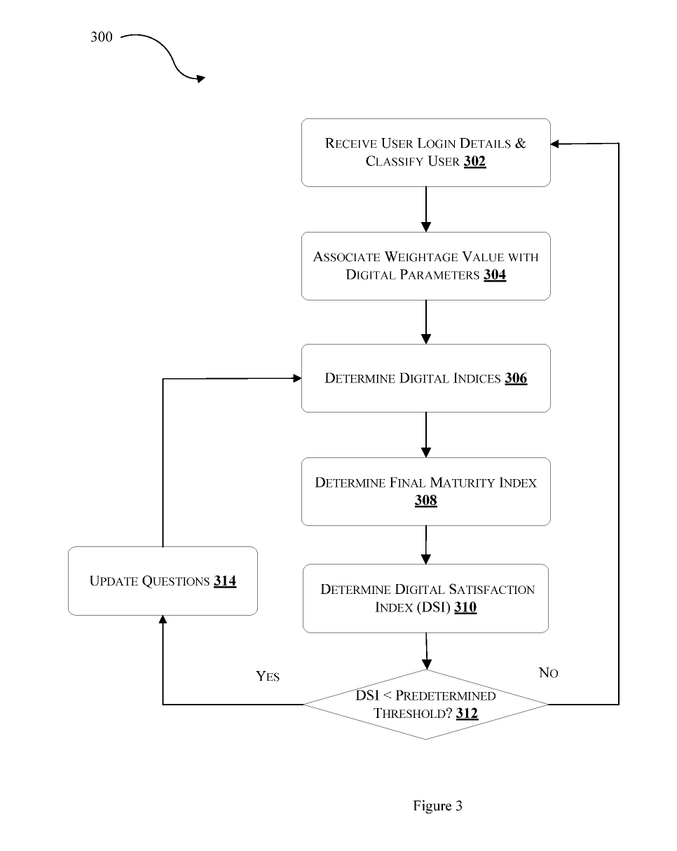

FIG. 3 illustrates a flowchart of method of determining maturity of the organization in accordance with an embodiment of the present disclosure.

As illustrated in FIG. 3, the method 300 comprises one or more blocks implemented by the rules engine 138 for determining maturity of the organization. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

The method 300 relates to determination of maturity index of the organization. Let us consider an example, an organization named Gamma Blues, an upcoming retailer who sell anything that is Blue in color for women, for example Blue shoes, Blue skirts, Blue jeans, Blue hats etc. The organization wanted to expand their business online and to use digital channels to capture the market. To identify digital possibilities and their digital maturity to sell Blue colored products, Gamma Blues determines digital maturity of their organization using the system 100.

A user of the organization Gamma Blues logs into the system 100 by providing necessary login information. The user may be for example, an Employee at Gamma Blues. The method 300 proceeds with receiving and verifying the user login details to authorize the user.

At block 302, receive and verify user login details. In one embodiment, the user interface module 110 is configured to validate a user who wishes to access or collaborate with the DIS 104. In one embodiment, the user interface module 110 receives the login details or the user account information of a user and authenticates the user based on valid login information. The user is authenticated by comparing the user account information received from the user with login information previously stored at the time of registering the user.

Upon validating the authenticity of the user, the user interface module 110 categorizes or classifies the user into one or more categories including Employee, Supplier, Customer, Investor, and so on. In another embodiment, the user may be categorized as one of Employee- Admin, Employee- SME and so on. Each categorized user may be assigned with one or more access controls on the DIS 104 determined by the rules engine 138. The rules engine 138 may be implemented by, for example, the processor 202 configured to determine the one or more access controls based on user data stored in the user database 112 and to assign the access controls to the categorized user. Based on the access controls, the user may access or retrieve the data stored in the analytics database 116 and the user database 112.

At block 304, associate weightage value with digital parameters. In one embodiment, the user interface module 110 receives a first data associated with the one or more digital parameters 212 related to digital infrastructure of the organization. The user is provided with a series of questions related to the one or more digital parameters based on the category of the user. In response to the queries, the user provides the first data related to the one or more digital parameters 212 including digital engagement, digital experience, digital commerce, digital process and digital integration associated with digital enablement of the organization.

Upon receiving the first data, the digital ranking module 130 of the digital experience module 118 determines a weightage value 214 corresponding to the one or more digital parameters 212 based on the received first data and associates the determined weightage value 214 to the one or more digital parameters 212. The weightage value for example may vary from 0 to 1. The digital ranking module 130 determines and associates any value between 0 and 1 to each of the one or more digital parameters 212 based on the first data and stores the associated weightage values in the digital ranking repository 114 for further processing.

For example, the user of the organization Gamma Blues is provided with a series of questions related to the one or more digital parameters. The user provides his/her input to the series of questions and based on the response, the digital ranking module 130 assigns a weightage value to each of the digital parameters. An illustration of digital parameter and associated weightage selected by the user is shown in table 1 below.

TABLE 1

| | | | Weightage |
|---|---|---|---|
| | Minimum | Maximum | selected by |
| Digital Parameter | Value | Value | the user |
| Digital | 0 | 1 | 1 |
| Engagement | | | |
| Digital Experience | 0 | 1 | 1 |
| Digital Commerce | 0 | 1 | 1 |
| Business Process | 0 | 1 | 0.75 |
| Management | | | |
| Integration | 0 | 1 | 0.75 |

At block 306, determine digital indices. In one embodiment, the rules engine 138 determines one or more digital indices 220 of corresponding one or more digital parameters 212 based on the received second data. For example, the user of the organization Gamma Blues is provided with a series of questions related to the one or more digital parameters to determine the digital indices. The user provides his/her input to the series of questions and based on the response, the rules engine 138 determines the one or more digital indices 220 including, but not limited to, a Digital Engagement Index, a Digital Experience Index, a Digital Commerce Index, a Digital Process Index and a Digital Integration Index. In one example, the values of the one or more digital indices may vary from 1 to 5.

A sample illustration of series of questions related to each digital parameter provided to the user in order to determine the corresponding digital index is shown in tables 2-6 below.

Digital Engagement

TABLE 2

| | Question | Level |
|---|---|---|
| A | Does the organization has fundamental page tracking | 1 |
| | mechanisms TO YIELD fundamental web metrics | |
| B | Does the organization use metrics and known analytics | 2 |
| | to influence visitor behavior, observe visitors, match | |
| | with appropriate content | |
| C | Does the organization leverage customized layouts | 3 |
| | based on data sources and content types on areas of | |
| | interest | |
| D | Does the organization use marketing suites and CRMs | 4 |
| | which can enable a continuous feedback loop | |
| E | Does the organization engage visitors 1 × 1 in a highly | 5 |
| | customized fashion | |

In one embodiment, the user selects C, and the rules engine 138 selects the corresponding Level 3. Thus the rule engine 138 determines the Digital Engagement Index as 3.

Digital Experience Management

TABLE 3

| | Question | Level |
|---|---|---|
| A | Does the organization begin to align digital initiatives | 1 |
| | with strategic objectives | |
| B | Is there a focus to optimize digital initiatives where | 2 |
| | analytics is used as an actionable insight | |
| C | Is there a focus on customer and the organization is | 3 |
| | building strong customer relationship using a digital | |
| | channel | |
| D | Did the organization establish data and infrastructure, | 4 |
| | connecting online and offline channels | |
| E | Does the organization intelligently predict user behavior | 5 |

In one embodiment, the user selects B, and the rules engine 138 selects the corresponding Level 2. Thus the rule engine 138 determines the Digital Experience Index as 2.

Digital Commerce

TABLE 4

| | Question | Level |
|---|---|---|
| A | Does the organization begin using catalog based pricing | 1 |
| B | Does the organization bridge online and offline | 2 |
| | channels and uses multiple channels to cater to their | |
| | customers | |
| C | Does the organization visually engage customers on the | 3 |
| | shopping carts | |
| D | Does the organization focus on customer with a | 4 |
| | conversation element | |
| E | Does the organization focus on experimental analysis to | 5 |
| | provide customer focus | |

In one embodiment, the user selects A and the rules engine 138 selects the corresponding Level 1. Thus the rule engine 138 determines the Digital Commerce Index as 1.

Business Process Management

TABLE 5

| | Question | Level |
|---|---|---|
| A | Is there basic cross system interaction | 1 |
| B | Does the organization have random service adoption | 2 |
| C | Does the organization has matured service adoption | 3 |
| D | Does the organization have established service adoption | 4 |
| | with implementation of a service oriented architecture | |
| E | Is the organization a process driven enterprise | 5 |

In one embodiment, the user selects D, and the rules engine 138 selects the corresponding Level 4. Thus the rule engine 138 determines the Business Process Management Index as 4.

Integration

TABLE 6

| | Question | Level |
|---|---|---|
| A | Intra enterprise integration | 1 |
| B | Infrastructure centric cloud integration | 2 |
| C | Application centric cloud integration | 3 |
| D | Business Centric cloud integration | 4 |
| E | Inter Business Cloud integration | 5 |

In one embodiment, the user selects D, and the rules engine 138 selects the corresponding Level 4. Thus the rule engine 138 determines the Digital Integration Index as 4.

At block 308, determine final maturity index. In one implementation, the rules engine 138 determines the final maturity index indicative of the digital maturity of the organization based on the weightage value and the one or more digital indices 220 determined as above. In one embodiment, the rules engine 138 retrieves the stored weightage values 214 of corresponding one or more digital parameters 212 from the digital ranking repository 114 via the digital information systems module 224. The digital information system module 224 provides a user interface to the rules engine 138 to enable access of the stored weightage values 214 from the digital ranking repository 114. The rules engine 138 determines sum of the stored weightage values 214 to obtain a total weightage value. For example, as per Table 7, the total of the stored weightage values 214 is determined to be 4.5.

The rules engine 138 determines one or more digital maturity indices of the one or more digital parameters 212 based on the weightage values and one or more predetermined capability factors associated with the one or more digital parameters 212. In one embodiment, one capability factor for each digital index is predetermined and stored in the memory 204. For example, the capability factor is 0.2 for digital index ‘1’, capability factor is 0.4 for digital index ‘2’, capability factor is 0.6 for digital index ‘3’, capability factor is 0.8 for digital index ‘4’ and capability factor is 1.0 for digital index ‘5’. As illustrated below in Table 7, the capability factor for each level of digital parameter is predetermined as 0.2 for Level 1, 0.4 for Level 2, 0.6 for Level 3, 0.8 for Level 4, and 1.0 for Level 5. If the user has selected Level 3 for a digital parameter, then the corresponding capability factor is predetermined to be 0.6.

TABLE 7

| | | | | | | | Digital |
|---|---|---|---|---|---|---|---|
| | | Level | Level | Level | Level | Level | Maturity |
| | Weightage | 1 | 2 | 3 | 4 | 5 | Index |
| Capability | | 0.2 | 0.4 | 0.6 | 0.8 | 1.0 | |
| Factor | | | | | | | |
| Digital | 1 | | | 1 | | | 0.6 |
| Engagement | | | | | | | |
| Digital | 1 | | 1 | | | | 0.4 |
| Experience | | | | | | | |
| Digital | 1 | 1 | | | | | 0.2 |
| Commerce | | | | | | | |
| Business | 0.75 | | | | 1 | | 0.6 |
| Process | | | | | | | |
| Management | | | | | | | |
| Integration | 0.75 | | | | 1 | | 0.6 |
| | 4.5 | | | | | | 2.4 |

The rules engine 138 determines one or more digital maturity indices (DMI) by multiplying the capability factor of one or more digital parameters 212 with the corresponding weightage value 214. In one embodiment, the digital maturity index of a digital parameter is determined as weightage value 214 of the digital parameter * capability for corresponding level.

For example, as per Table 7,

DMI of Digital Engagement=Weightage*Capability for Level=0.6*1=0.6

DMI of Digital Experience=Weightage*Capability for Level=0.4*1=0.4

DMI of Digital Commerce=Weightage*Capability for Level=0.2*1=0.4

DMI of BPM=Weightage*Capability for Level=0.75*0.8=0.6

DMI of Integration=Weightage*Capability for Level=0.75*0.8=0.6

The rules engine 138 further determines the total of the one or more digital maturity indices to obtain a total digital maturity index as mentioned below

Total Digital Maturity Index of the organization=0.6+0.4+0.2+0.6+0.6=2.4

The final maturity index 216 of the organization is determined based on the total digital maturity index of the organization, a predetermined maximum capability factor for example, 5 and the total weightage value as illustrated below:

The final Digital Maturity Index of the organization=(2.4*5)/4.5=2.67

At block 310, determine digital satisfaction index. In one embodiment, the rules engine 138 also determines a digital satisfaction index (DSI) 218 to determine the satisfaction level of the users using the DMDD 106. In one embodiment, the rules engine 138 provides one or more queries related to satisfaction level of the users about the DMDD 106 and receive data in response to queries from the users. Based on the received data, the rules engine 138 determines the DSI 218.

At block 312, determine whether the DSI 218 is lesser than the predetermined satisfaction threshold value. In one embodiment, the rules engine 138 determines as to whether the DSI 218 is lesser than the predetermined satisfaction threshold value. If the DSI is determined to be lesser, then the method proceeds to block 314 along the ‘YES’ path, otherwise proceeds to block 302 along the ‘NO’ path to repeat the entire method steps.

At block 314, update questions. In one embodiment, if the DSI 218 is determined to be lesser than the predetermined satisfaction threshold value, then the rules engine 138 enables modification of the one or more queries associated with the one or more digital parameters 212 and proceeds to determine digital indices of the one or more digital parameters 212.

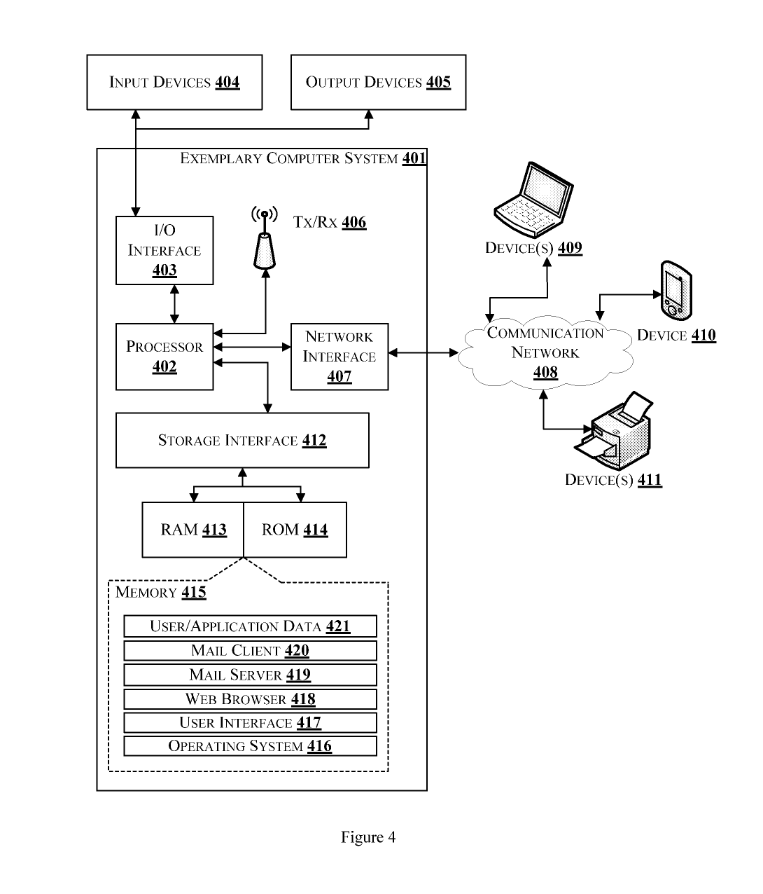

FIG. 4 is a block diagram of an exemplary computer system for implementing embodiments consistent with the present disclosure.

Variations of computer system 401 may be used for implementing all the computing systems that may be utilized to implement the features of the present disclosure. Computer system 401 may comprise a central processing unit (“CPU” or “processor”) 402. Processor 402 may comprise at least one data processor for executing program components for executing user- or system-generated requests. The processor may include specialized processing units such as integrated system (bus) controllers, memory management control units, floating point units, graphics processing units, digital signal processing units, etc. The processor 402 may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface 407 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 409, 410, and 411. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 4Error! Reference source not found.14, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 415 may store a collection of program or database components, including, without limitation, an operating system 4Error! Reference source not found.16, user interface application 4Error! Reference source not found.17, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As described above, the modules 210, amongst other things, include routines, programs, objects, components, and data structures, which perform particular tasks or implement particular abstract data types. The modules 210 may also be implemented as, signal processor(s), state machine(s), logic circuitries, and/or any other device or component that manipulate signals based on operational instructions. Further, the modules 210 can be implemented by one or more hardware components, by computer-readable instructions executed by a processing unit, or by a combination thereof.

The specification has described a method and a system for determining digital maturity of an organization. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of determining digital maturity of an organization comprising:
receiving, by an organization management computing device, from one or more users, a first data associated with one or more digital parameters related to a digital infrastructure of the organization;
associating, by the organization management computing device, a weightage value to the one or more digital parameters based on the received data;
determining, by the organization management computing device, one or more digital indices for the one or more digital parameters based on a second data provided by the one or more users in response to one or more queries associated with the one or more digital parameters; and
determining, by the organization management computing device, a final digital maturity index based on the associated weightage value and the one or more determined digital indices of the one or more digital parameters.

2. The method as set forth in claim 1, wherein the determining the final digital maturity index further comprises:
determining, by the organization management computing device, one or more digital maturity indices of the one or more digital parameters based on the weightage value of the one or more digital parameters and one or more capability factors associated with the one or more determined digital indices;
calculating, by the organization management computing device, a total digital maturity index as sum of the one or more determined digital maturity indices; and
determining, by the organization management computing device, the final digital maturity index based on the calculated total digital maturity index, a predetermined maximum capability factor, and a total weightage value of the one or more digital parameters.

3. The method as set forth in claim 2, wherein the total weightage value is the sum of the weightage values associated with the one or more digital parameters.

4. The method as set forth in claim 1, further comprising:
receiving, by the organization management computing device, user login information from the one or more users;
authenticating, by the organization management computing device, the one or more users based on the received user login information; and
classifying, by the organization management computing device, the one or more users into one or more categories based on the authentication.

5. The method as set forth in claim 1, wherein the one or more digital parameters comprise a digital engagement, a digital experience, a digital commerce, a digital process, or a digital integration associated with the digital infrastructure of the organization.

6. The method as set forth in claim 1, further comprising:
receiving, by the organization management computing device, data from the one or more users in response to queries related to satisfaction level of the one or more users;
determining, by the organization management computing device, a digital satisfaction index based on the received satisfaction level data; and
modifying, by the organization management computing device, the one or more queries associated with the one or more digital parameters based on the determined digital satisfaction index.

7. An organization management computing device comprising:
a processor; and
a memory coupled to the processor which is configured to be capable of executing programmed instructions comprising and stored in the memory to:
receive, from one or more users, a first data associated with one or more digital parameters related to a digital infrastructure of an organization;
associate a weightage value to the one or more digital parameters based on the received data;
determine one or more digital indices for the one or more digital parameters based on a second data provided by the one or more users in response to one or more queries associated with the one or more digital parameters; and
determine a final digital maturity index based on the associated weightage value and the one or more determined digital indices of the one or more digital parameters.

8. The device as set forth in claim 7, wherein the processor coupled to the memory is further configured to be capable of executing programmed instructions further comprising and stored in the memory to determine the final digital maturity index comprising:
determining one or more digital maturity indices of the one or more digital parameters based on the weightage value of the one or more digital parameters and one or more capability factors associated with the one or more determined digital indices;
calculating a total digital maturity index as sum of the one or more determined digital maturity indices; and
determining the final digital maturity index based on the calculated total digital maturity index, a predetermined maximum capability factor, and a total weightage value of the one or more digital parameters.

9. The device as set forth in claim 8, wherein the total weightage value is the sum of the weightage values associated with the one or more digital parameters.

10. The device as set forth in claim 7, wherein the processor coupled to the memory is further configured to be capable of executing additional programmed instructions comprising and stored in the memory to:
receive user login information from the one or more users;
authenticate the one or more users based on the received user login information; and
classify the one or more users into one or more categories based on the authentication.

11. The device as set forth in claim 7, wherein the one or more digital parameters comprise a digital engagement, a digital experience, a digital commerce, a digital process, or a digital integration associated with the digital infrastructure of the organization.

12. The device as set forth in claim 7, wherein the processor coupled to the memory is further configured to be capable of executing additional programmed instructions comprising and stored in the memory to:
receive data from the one or more users in response to queries related to satisfaction level of the one or more users;
determine a digital satisfaction index based on the received satisfaction level data; and
modify the one or more queries associated with the one or more digital parameters based on the determined digital satisfaction index.

13. A non-transitory computer readable medium having stored thereon instructions for determining digital maturity of an organization comprising executable code which when executed by a processor, causes the processor to perform steps comprising:
receiving, from one or more users, a first data associated with one or more digital parameters related to a digital infrastructure of the organization;
associating a weightage value to the one or more digital parameters based on the received data;
determining one or more digital indices for the one or more digital parameters based on a second data provided by the one or more users in response to one or more queries associated with the one or more digital parameters; and
determining a final digital maturity index based on the associated weightage value and the one or more determined digital indices of the one or more digital parameters.

14. The medium as set forth in claim 13, wherein the determining the final digital maturity index further comprises:
determining one or more digital maturity indices of the one or more digital parameters based on the weightage value of the one or more digital parameters and one or more capability factors associated with the one or more determined digital indices;
calculating a total digital maturity index as sum of the one or more determined digital maturity indices; and
determining the final digital maturity index based on the calculated total digital maturity index, a predetermined maximum capability factor, and a total weightage value of the one or more digital parameters.

15. The medium as claimed in claim 14, wherein the total weightage value is the sum of the weightage values associated with the one or more digital parameters.

16. The medium as claimed in claim 13 further comprising executable code which when executed by a processor, causes the processor to perform steps further comprising:
receiving user login information from the one or more users;
authenticating the one or more users based on the received user login information; and
classifying the one or more users into one or more categories based on the authentication.

17. The medium as claimed in claim 13, wherein the one or more digital parameters comprise a digital engagement, a digital experience, a digital commerce, a digital process, or a digital integration associated with the digital infrastructure of the organization.

18. The medium as claimed in claim 13 further comprising executable code which when executed by a processor, causes the processor to perform further steps comprising:
receiving data from the one or more users in response to queries related to satisfaction level of the one or more users;
determining a digital satisfaction index based on the received satisfaction level data; and
modifying the one or more queries associated with the one or more digital parameters based on the determined digital satisfaction index.
